(19) United States
(12) Patent Application Publication
(10) Pub. No.: US 2004/0021605 A1
(43) Pub. Date: Feb. 5, 2004

(54) Multiband antenna for mobile devices

(76) Inventors: Charles Ngounou Kouam, Les Ulis (FR); Andre Marie Ngounou Kouam, Yaounde (CM); Marc Edimo, Les Ulis (FR); Jean-Philippe Coupez, Le Releeq keshuon (FR); Francois Lepennec, Porspoder (FR)

Correspondence Address: SUGHRUE MION, PLLC, 2100 PENNSYLVANIA AVENUE, N.W., WASHINGTON, DC, 20037, US

(21) Appl. No.: 10/220,598

(22) PCT Filed: Jan. 3, 2002
(86) PCT No.: PCT/FR02/00012

(30) Foreign Application Priority Data
Jan. 4, 2001 (FR) 01/00079

(51) Int. Cl. H01Q 1/38; H01Q 1/24

(52) U.S. Cl. 343/700 MS; 343/702

(57) ABSTRACT

The invention provides an antenna (1) for a mobile radio system, the antenna comprising two radiating conductive planes (2, 5) electrically connected together (at 4), a slot (3) in at least one of the planes, a feeder connection (6) disposed on one of the conductive planes, and a short circuit connection (7) connected to a ground (8) disposed on the same conductive plane as the feeder connection.

The invention also provides a mobile radio device including an antenna according to the invention.

The invention further provides a method of fabricating the above kind of antenna, including a step of cutting slots in a metal film and a step of bending the metal film to superpose two portions of the film.

The invention relates to patch antennas. A patch antenna is typically used in a range of the spectrum including radio frequencies and microwave frequencies.

Most antennas have one resonant frequency band. For transmission, when the antenna is excited in this frequency band by a feeder line, it supports standing electromagnetic waves. The standing waves are then coupled to electromagnetic waves radiated into space. For reception, the waves take the same forms but follow the path in the reverse order. Various antennas of the above type are known in the art.

Using microstrips-on a plane as an antenna for transmitting signals is known in the art. Conductive patches are disposed on the top face of a dielectric substrate and a conductive layer is placed on the bottom face of the substrate. The substrate typically has a plane rectangular shape of constant thickness.

A multiband antenna is described in the document FR-A-2772518. The antenna includes a flat patch disposed on the top surface of a dielectric substrate. A ground layer is disposed on the bottom surface of the dielectric substrate. The antenna is of the quarter-wave type because a short circuit conductor disposed on an edge of the dielectric substrate connects the patch to the ground layer. The antenna includes connecting conductors for transmitting signals between the antenna and a signal processor device.

A paper presented at the Davos AP 2000 conference by Ollikainen, Kivekäs, Toropainen and Vainikainen describes a multiband antenna. The antenna includes three patches placed on the top surface of a Styrofoam (Registered Trade Mark) substrate. A ground layer is placed on the bottom surface of the dielectric substrate. A first patch intended for the low band is joined to a second patch intended for the high band. The two patches thus form a first two-band element having a zig-zag shape and including a feeder. The two-band element includes a short circuit in the form of a junction with the ground layer. A third patch is positioned beside the second patch to obtain a double resonance in the high band, with an enlarged bandwidth. The third path includes a short circuit in the form of a junction with the ground layer.

The paper “Novel meandered planar inverted F-antenna for triple frequency operation” published in Microwave And Optical Technology Letters, page 58, volume 27, No. 1, Oct. 5, 2000, describes a multiband antenna. The antenna includes three patches placed in the same plane as a ground layer in a “meandered” pattern. The three patches include a single feeder.

The above antennas have drawbacks. On the one hand, they necessitate large flat patches, which is incompatible with the small dimensions of mobile communication equipment casings. On the other hand, they necessitate the fitting of capacitive loads to enlarge the bandwidth, which increases the cost and complexity of the antenna. Additionally, they usually need to be fed from their center if a good level of matching is to be obtained.

Furthermore, they have a limited number of resonant frequency bands, whose bandwidth is also limited, and thus do not process all the frequency bands used to transmit information. It can therefore be necessary to equip devices with different antennas according to the country in which they are used. Nor is it easy to adjust the resonant frequencies and bandwidths.

There is therefore a need for an antenna that solves the above problems.

The invention provides an antenna comprising two radiating conductive planes electrically connected together, a slot in at least one of the radiating conductive planes, a feeder connection disposed on and physically connected to one of the planes, and a short circuit connection disposed on and physically connected to the same conductive plane as the feeder connection.

In one variant the conductive planes are electrically connected by one of their edges.

In another variant the slot, the short circuit connection and the feeder connection are disposed in the same conductive plane.

In a further variant the conductive planes are formed by a bent metal film.

In a still further variant the feeder connection is a tongue formed in the metal film.

In another embodiment the short circuit connection is a tongue formed in the metal film.

In one variant the slot extends over both conductive planes.

In another variant the conductive planes have different dimensions.

In a further variant the antenna includes a dielectric substrate disposed between the two conductive planes.

In one variant the antenna includes a dielectric substrate disposed between one of the conductive planes and a ground.

In another variant at least one of the substrates is made from a material having a relative permittivity of less than 2.

In a further variant at least one of the substrates is made from a material having a dissipation factor of less than 10⁻³.

The antenna can also have at least two resonance bands, one of the two resonance bands being formed by two complementary resonant frequencies.

In one variant the antenna has at least three resonance bands.

The invention also provides a mobile radio device which includes an antenna according to the invention and is less than 20 mm thick, less than 120 mm long and less than 50 mm wide.

The invention further provides a method of fabricating a multiband antenna including a step of cutting a slot, a feeder connection, and a short circuit connection into a metal film and a step of bending the metal film to superpose two portions of the film.

In one variant the method further includes a step of making a plane electrical connection between two conductive planes by making two substantially parallel bends in the film.

Other features and advantages of the invention will become apparent on reading the following description of embodiments of the invention, which description is given by way of example and with reference to the accompanying drawings, in which:

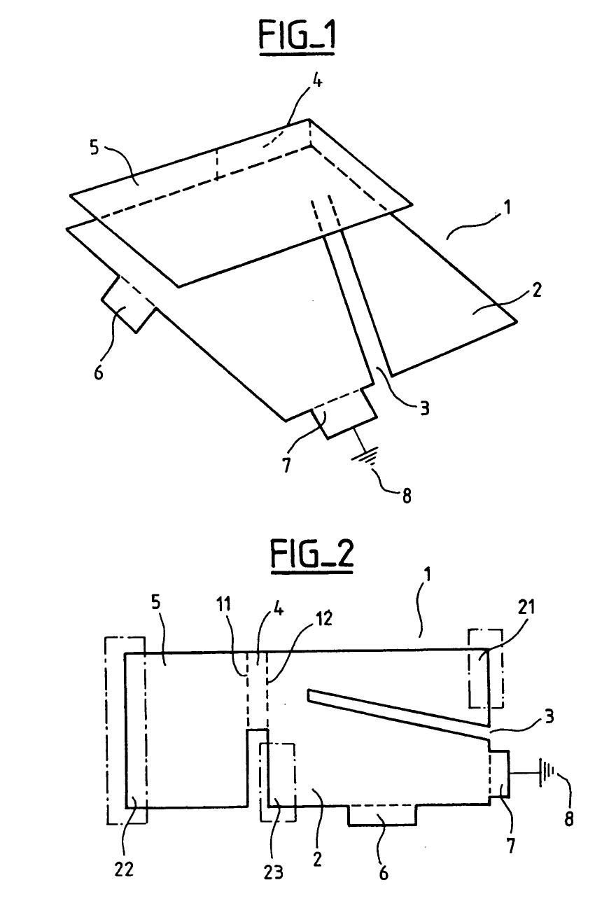

FIG. 1 is a perspective view of a first embodiment of an antenna according to the invention,

FIG. 2 is a plan view of the FIG. 1 antenna with the conductive planes aligned,

FIG. 3 is a perspective view of a second embodiment of an antenna according to the invention,

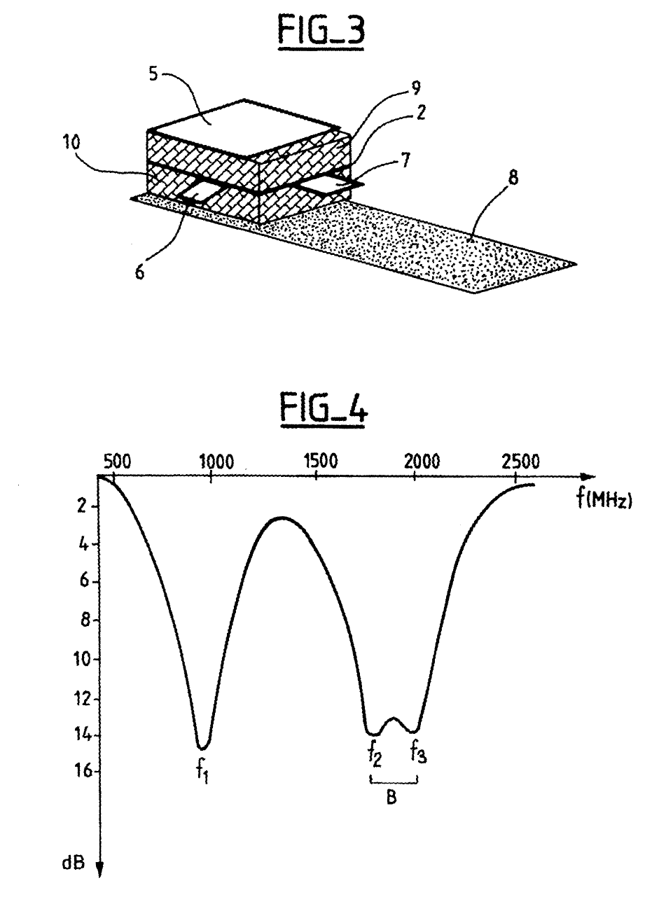

FIG. 4 is a diagram of the typical reflection frequency spectrum of an antenna conforming to the second embodiment,

FIG. 5 is a plan view of a test antenna whose conductive planes are aligned, and

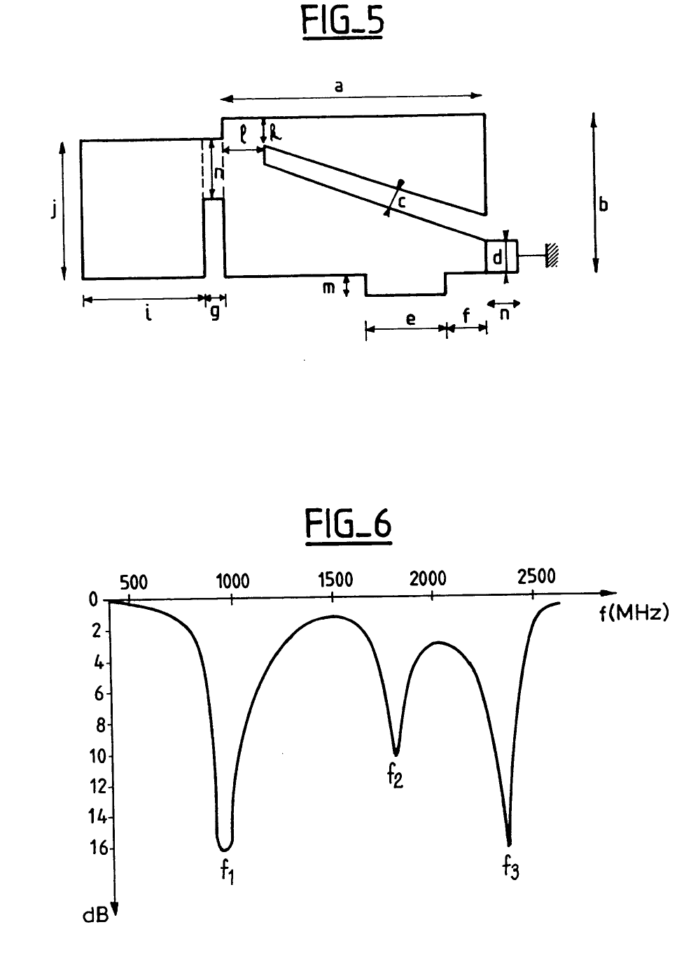

FIG. 6 is a diagram of the reflection frequency spectrum at the input of the FIG. 5 antenna.

The invention proposes an antenna in which a second conductive plane is superposed on a first conductive plane incorporating a slot, the two planes being connected electrically.

The antenna is described hereinafter when operating as a transmit antenna, converting an electrical current into an electromagnetic field. It will be evident to the person skilled in the art that the operation of the antenna as a receive antenna is similar, the antenna converting an electromagnetic field into an electrical current.

FIG. 1 is a perspective view of a first embodiment of an antenna according to the invention. FIG. 2 shows the same antenna when the conductive planes are aligned in the same plane. The antenna 1 has a first radiating conductive plane 2 in which is formed a slot 3 extending from one edge of the plane. The first radiating conductive plane 2 is electrically connected to a second radiating conductive plane 5 by an electrical connection 4 on the opposite edge, here taking the form of a conductive strip with a particular width. The second conductive plane is superposed on the first conductive plane, as shown in FIG. 1. The superposition of the conductive planes 2 and 5 reduces the surface area of the antenna compared to prior art antennas.

The first conductive plane has a feeder connection 6 and a short circuit connection 7 connected to a ground 8. To be more precise, the feeder connection 6 and the short circuit connection 7 are in physical contact with at least one of the conductive planes.

The feeder connection 6 is usually connected to a signal generator and processor, not shown, which produces a signal in the form of an electrical current.

A first resonant mode is obtained by means of the slot 3, isolating two edges of the first radiating conductive plane 2. An electrical current circumvents the slot. The electrical path runs from the short circuit connection to the radiating area 21 indicated in chain-dotted line in FIG. 2. An electromagnetic field is generated by induction in the radiating area 21. The wavelength of the electromagnetic field is determined by the length of the slot, i.e. its greatest dimension. The resonance is of the quarter-wave type because the short circuit connection imposes an electrical field node. Thus the length of the electrical path is of the order of λ/4, where λ is the radiated wavelength.

A second resonant mode is obtained by means of the second radiating conductive plane superposed on the first. The second conductive plane is excited, on the one hand, by electromagnetic coupling to the first conductive plane and, on the other hand, by direct electrical coupling to the same plane via the electrical connection 4. Thus a quarter-wave resonance is generated in the second conductive plane. The electromagnetic field is generated mainly in the radiating area 22. The resonant frequency is determined by the dimensions of the first and second conductive planes. Thus the length to be taken into consideration for determining the resonant frequency of this mode substantially corresponds to the distance between the short circuit connection and the radiating area 22. The conductive plane being short circuited by the connection 4 and the short circuit connection 7, the dimensions of the antenna can therefore be reduced for a given resonant frequency. Moreover, the overall surface area of the antenna is reduced because the conductive plane 5 is superposed on the conductive plane 2.

A third resonant mode is generated in the first conductive plane by the combination of the feeder connection and the short circuit connection. This is because, given its disposition, the feeder connection 6 excites the first conductive plane 2 directly and the latter, when it radiates, excites in turn the slot 3 and the second conductive plane 5.

The ground produces a quarter-wave resonance by imposing an electrical field node at the short circuit and a belly at the opposite edge, i.e. in the radiating area 23. The greatest dimension of the conductive plane, i.e. the distance between the short circuit connection and the radiating area 23, is of the order of one quarter of the radiated wavelength.

The overlapping of the radiating area 23 of the first conductive plane by the second conductive plane strongly influences the values of the frequencies f2 and f3 through electromagnetic coupling of the two conductive planes. Accordingly, the superposition of the radiating areas of the two conductive planes 2 and 5 causes significant modification of the values of the frequencies f2 and f3 relative to the values obtained from the quarter-wave model.

In the embodiment shown in FIGS. 1 and 2, a second conductive plane is used with dimensions significantly different from the dimensions of the first conductive plane. Using a second conductive plane with dimensions similar to those of the first conductive plane produces a second resonant frequency far away from the third resonant frequency. Three separate resonant frequencies can be obtained with appropriate slot dimensions. This increases the number of frequency bands in which the antenna can transmit. On the other hand, using a second conductive plane with smaller dimensions produces a second resonant frequency close to the third resonant frequency.

In the embodiment shown in FIGS. 1 and 2 the conductive planes are connected by the electrical connection 4. The connection 4 is therefore placed at one edge of the conductive planes 2 and 5. In this instance it takes the form of a metal strip with a particular width. This type of connection, effected at the edges of the conductive planes, is easy to fabricate, especially by the method described hereinafter. However, in the context of the invention, it is also possible to effect the electrical connection between the conductive planes elsewhere than at their edge. Thus they can equally well be connected at appropriate points in their central areas.

The width of the electrical connection 4 influences the values of the resonant frequencies f2 and f3. Thus reducing the widths of the connection 4 reduces the resonant frequencies f2 and f3. Localizing the connection 4 to the width of the planes 2 and 5 also influences the value of the resonant frequency f2. The greater the distance of the connection 4 from the short circuit connection 7, the lower the frequency f2.

The feeder connection is coupled to an emitter or to a signal processor unit by a connecting line that is not shown. This connection can be made by a coaxial cable, for example. To avoid unwanted reflections of signals between the feeder connection and the emitter, for example, it is preferable to have a uniform impedance all along the connecting line. To this end, it is useful for the connecting line to take the form of a tongue starting from a conductive plane and extended to form the connecting line.

Moreover, to optimize the gain, i.e. the ratio between the power of the signal radiated by the antenna and the power of the signal emitted by the emitter, it is desirable for the input impedance of the antenna to be equal to the output impedance of the emitter or the signal processor device. That impedance is preferably set at 50 ohms to minimize losses.

To improve the gain and facilitate fabrication of the antenna, it is also preferable to dispose the feeder connection and/or the short circuit connection at the edges of the conductive planes. Disposing the short circuit connection at one edge of the antenna imposes a null electrical field at this point. In this way it is possible to impose quarter-wave operation on the antenna. Disposing the feeder connection at an edge of a conductive plane improves the level of matching.

The feeder connection 6 and the short circuit connection 7 are preferably disposed on the same conductive plane. This makes it easier to control the input impedance of the antenna. Modifying the position of the feeder connection relative to the short circuit connection modifies the resonant frequencies and the matching levels. The connections 6 and 7 are therefore placed at suitably chosen locations.

FIG. 3 shows a second embodiment of an antenna according to the invention. A substrate 9 is disposed between the second conductive plane 5 and the first conductive plane 2. The substrate imparts mechanical strengths to the conductive planes. The substrate can also be used to hold the conductive planes a fixed distance apart. It is desirable to choose a substrate material whose relative permittivity is close to that of air, and preferably less than 2. A material is preferably chosen that has a very low dissipation factor, to be more specific a dissipation factor less than 10⁻³. This improves the gain of the antenna. Thus the substrate 9 can be made from a foam material such as a polymethacrylimide foam. This kind of foam provides good mechanical strength.

A substrate 10 can also be disposed between one of the conductive layers and a flat ground 8. To enable a ground return tongue to be bent, a substrate 10 is used with one edge level with or set back relative to an edge of the first conductive plane, as shown in FIG. 3. This simplifies assembly of the antenna. To improve the gain, it is also desirable to make the substrate from a material whose relative permittivity is close to that of air, and preferably less than 2. It is also preferable to choose a material having a very low dissipation factor. Materials similar to those described for the substrate 9 can be used, for example. A substrate thickness is preferably chosen such that the frequencies can be tuned and the bandwidths enlarged. The thickness of the substrate 10 is limited by the dimensions of the mobile radio device.

In the FIG. 3 embodiment, the slot extends substantially the whole length of the first conductive plane. The resonant frequencies f2 and f3 are fairly close together. Thus the resonance at frequency f2 is complementary to the resonance at frequency f3 to form a frequency band of greater bandwidth. As the slot 3 extends substantially the whole length of the conductive plane 2, the resonant frequency f1 is approximately half the frequency f3.

In the embodiments shown, the slot 3 is rectangular. It is inclined to the edges of the conductive plane incorporating it—which is of substantially parallelepiped shape—to maximize its length, whilst retaining a minimum dimension of the conductive plane.

FIG. 4 shows an antenna input reflection frequency spectrum typical of an antenna conforming to the second embodiment. A low reflection of the antenna at a given frequency corresponds to a resonance. Note that the frequencies f2 and f3 are complementary to form an enlarged frequency band B.

FIG. 5 is a plan view of a test antenna whose conductive planes are aligned. The antenna has the following dimensions:

| | | | |
|---|---|---|---|
| a = 40 mm | b = 25 mm | c = 0.75 mm | d = 7 mm |
| e = 10 mm | f = 5 mm | g = 3 mm | h = 8 mm |
| i = 22 mm | j = 22 m | k = 3 mm | l = 3 mm |
| m = 4 mm | n = 5 mm | | |

The conductive planes are formed from bent copper film 100 μm thick. The electrical connection is formed by the bent edge of the film. The antenna has a substrate between the two conductive planes and a substrate between the first conductive plane and a ground. Both substrates are made of polymethacrylimide foam.

The FIG. 6 diagram represents the antenna input reflection frequency spectrum of the FIG. 5 embodiment. The first resonant frequency f1 can be used in the E-GSM band (880-960 MHz). The second resonant frequency f2 can be used in the DCS band (1710-1880 MHz) or the PCS band (1850-1990 MHz). It is higher than the first frequency f1 because the electrical path for this resonant frequency is shorter than the electrical path for the first resonant frequency. The third resonant frequency f3 is higher than the second frequency f2. The third frequency f3 can be used in the UMTS band (1900-2170 MHz), for example.

As for the test antenna described, a bent metal film can be used to form the conductive planes. It is also possible to make the feeder connection in the form of a tongue formed in the metal film. It is also possible to make the short circuit connection in the form of a tongue formed in the metal film.

The invention further relates to a mobile radio device comprising an antenna as previously described. The antenna can be disposed inside a protective casing of the device.

The invention also relates to a method of fabricating an antenna. The fabrication method includes a step of cutting a slot in a metal film. It further includes a step of bending the metal film to superpose two portions of the metal film. In one variant, the bending step includes making a plane electrical connection between the two conductive planes by forming two substantially parallel bends 11 and 12 in the film.

In one variant, the method includes a step of cutting out a short circuit tongue. In another variant, the method includes a step of cutting out a feeder connection. In a further variant, the method includes a step of cutting out an electrical connection over a portion of the width of the metal film.

Of course, the present invention is not limited to the examples and embodiments described and shown, and lends itself to many variations that will be evident to the skilled person.

Thus, although conductive planes have been described until now, it is equally possible to use curved conductive surfaces, for example to espouse the shape of a mobile telephone casing. It is equally possible to make a slot that extends over both conductive planes, passing through the electrical connection. Conductive planes with shapes other than the rectangles shown can also be used, as well as corrugated or curved conductive surfaces. It remains possible to bend the feeder and short circuit tongues if necessary.

1. A multiband antenna (1) comprising:
two radiating conductive planes (2, 5) electrically connected together (at 4),
a slot (3) in at least one of the radiating conductive planes,
a feeder connection (6) disposed on and physically connected to one of the conductive planes, and
a short circuit connection (7) disposed on and physically connected to the same conductive plane as the feeder connection.

2. The antenna of claim 1, characterized in that the conductive planes are electrically connected (at 4) by one of their edges.

3. The antenna of either claim 1 or claim 2, characterized in that the slot, the short circuit connection and the feeder connection are disposed in the same conductive plane.

4. The antenna of any preceding claim, characterized in that the conductive planes are formed by a bent metal film.

5. The antenna of claim 4, characterized in that the feeder connection is a tongue formed in the metal film.

6. The antenna of claim 4 or claim 5, characterized in that the short circuit connection is a tongue formed in the metal film.

7. The antenna of any of claims 1 to 6, characterized in that the slot extends over both conductive planes.

8. The antenna of any preceding claim, characterized in that the conductive planes have different dimensions.

9. The antenna of any preceding claim, characterized in that it includes a dielectric substrate (9) disposed between the two conductive planes.

10. The antenna of any preceding claim, characterized in that it includes a dielectric substrate (10) disposed between one of the conductive planes and a ground (8).

11. The antenna of claim 9 or claim 10, characterized in that at least one of the substrates (9, 10) is made from a material having a relative permittivity of less than 2.

12. The antenna of any of claims 9 to 11, characterized in that at least one of the substrates (9, 10) is made from a material having a dissipation factor of less than 10⁻³.

13. The antenna of any preceding claim, characterized in that it has at least two resonance bands, one of the two resonance bands being formed by two complementary resonant frequencies.

14. The antenna of any preceding claim, characterized in that it has at least three resonance bands.

15. A mobile radio device characterized in that it includes a multiband antenna according to any preceding claim.

16. A mobile radio device according to claim 15, characterized in that it is less than 20 mm thick, less than 120 mm long and less than 50 mm wide.

17. A method of fabricating a multiband antenna including a step of cutting a slot, a feeder connection, and a short circuit connection into a metal film and a step of bending the metal film to superpose two portions of the film.

18. The fabrication method of claim 16, characterized in that it further includes a step of making a plane electrical connection between two conductive planes by making two substantially parallel bends (11, 12) in the film.
